(19) United States
(12) Patent Application Publication
(10) Pub. No.: US 2009/0006121 A1
(43) Pub. Date: Jan. 1, 2009

(54) SYSTEM AND METHOD FOR WEB BASED AUTOMATIC LETTER WRITING

(76) Inventor: Timothy J. Coughlin, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/146,162

(22) Filed: Jun. 25, 2008

Related U.S. Application Data
(60) Provisional application No. 60/946,206, filed on Jun. 26, 2007.

(51) Int. Cl. G06Q 99/00

(52) U.S. Cl. 705/1

(57) ABSTRACT

A computer implemented correspondence writing and delivery service is disclosed. In one embodiment, the service allows a user, who is a subscriber to the service, to log on to a web site and generate portions of a letter, such as the body. The service then presents a number of potential recipients for the letter, such as, in one form, a listing of elected officials from the user's identified voting district. The user selects one or more recipients and a unique letter is generated for each, including their office address. According to one form, each unique letter is printed following creation in a customized fashion and dispatched for delivery to the recipient's address via a delivery method.

### CROSS REFERENCE TO RELATED APPLICATIONS

The present application claims the benefit of U.S. Provisional Patent Application Ser. No. 60/946,206 filed Jun. 26, 2007 entitled “System and Method for Web Based Automatic Letter Writing” which is hereby incorporated by reference in its entirety to the extent not inconsistent.

### FIELD OF THE INVENTION

The present invention relates to a system and method for providing automated letter writing. More particularly, the present invention relates to a web-based system and method for allowing users to automatically sent letters to various entities.

### BACKGROUND OF THE INVENTION

Many hot political topics exist in the United States today and will no doubt continue to arise in the future. Due to the large size of our nation, it can often be difficult for an elected official or representative to properly gauge the feeling of their constituents. Several common methods of reaching out to a representative include e-mail, telephone calls, personal visits, or letters. Of all of these, it is often believed that a well thought out and professionally presented letter is the most effective. However, only the most proactive citizens have the time and/or equipment to properly draft a letter to one, let alone a large percentage, of their elected officials. As a result, improvement is needed which will allow a casual politically motivated individual to easily draft and send a professional letter to an elected official or representative of their choice.

### SUMMARY OF THE INVENTION

In one form a web-based correspondence preparing, printing, and delivery process is provided. The process allows a user, who is a subscriber to the service, to log on to a web site and generate portions of a letter, such as the body, expressing their thoughts and feelings with respect to one or more political issues. The service then presents a number of potential recipients for the letter, such as a listing of elected officials from the user's identified voting district. The user selects one or more recipients and a unique letter is generated for each, including their office address. Each unique letter is then printed in a customized fashion and dispatched for delivery to the recipient's address.

In yet another form, a process allows a super user, such as a political candidate or activist group, to send letters to the users of the system who have expressed interest in a particular topic or set of topics, one way or another. As a result, a candidate or group is able to easily reach users with a personalized message regarding their political views and an explanation of how those may align with those of the candidate, or a call to action with respect to the group.

This summary is provided to introduce a selection of concepts in a simplified form that are described in further detail in the detailed description and drawings contained herein. This summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one implementation.

FIG. 2 is a flowchart illustrating the set of steps performed in one embodiment of the present invention for preparing and sending a letter to an entity.

### DESCRIPTION OF THE SPECIFIC EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Disclosed is an automated letter writing, printing, and delivery service. The service allows a user, who is a subscriber to the service, to log on to a web site and generate portions of a letter, such as the body, expressing their thoughts and feelings with respect to one or more political issues. The service then presents a number of potential recipients for the letter, such as a listing of elected officials from the user's identified voting district. The user selects one or more recipients and a unique letter is generated for each, including their office address. Each unique letter is then printed in a customized fashion and dispatched for delivery to the recipient's address.

The body of the letter created by the user may include form text stored by the service, free form text supplied by the user, or text generated by the service at the request of the user. Additionally, the recipients presented to the user for selection may include politicians, elected officials, appointed officials, office holders, candidates, or any other entity to which a letter may be sent. Each unique letter includes the address associated with the selected recipient stored by the service, the portions designated by the user, and a closing including a distinguishing signature. The delivery methods utilized to deliver a letter to the designated recipient may include, but are in no way limited to, U.S. Postal Service First Class Mail, certified mail, Priority Mail, Fed Ex, United Parcel Service, DHL, courier delivery service, and other similar delivery methods. Other delivery methods may be utilized including e-mail, facsimile, and the like without departing from the scope of the present invention.

The user may subscribe to the service in a variety of methods such as providing their information to a website, speaking with a customer service representative by phone, filling out a form, or by various other methods known to one of skill in the art. Additionally, at the time of subscription or thereafter, the user is preferably prompted to complete a user profile or information request, including the user's name, address, and nine digit zip code. Pricing models may include a fee per letter, fee per time period (i.e. month or year), fee per quantity of letters, or a combination thereof.

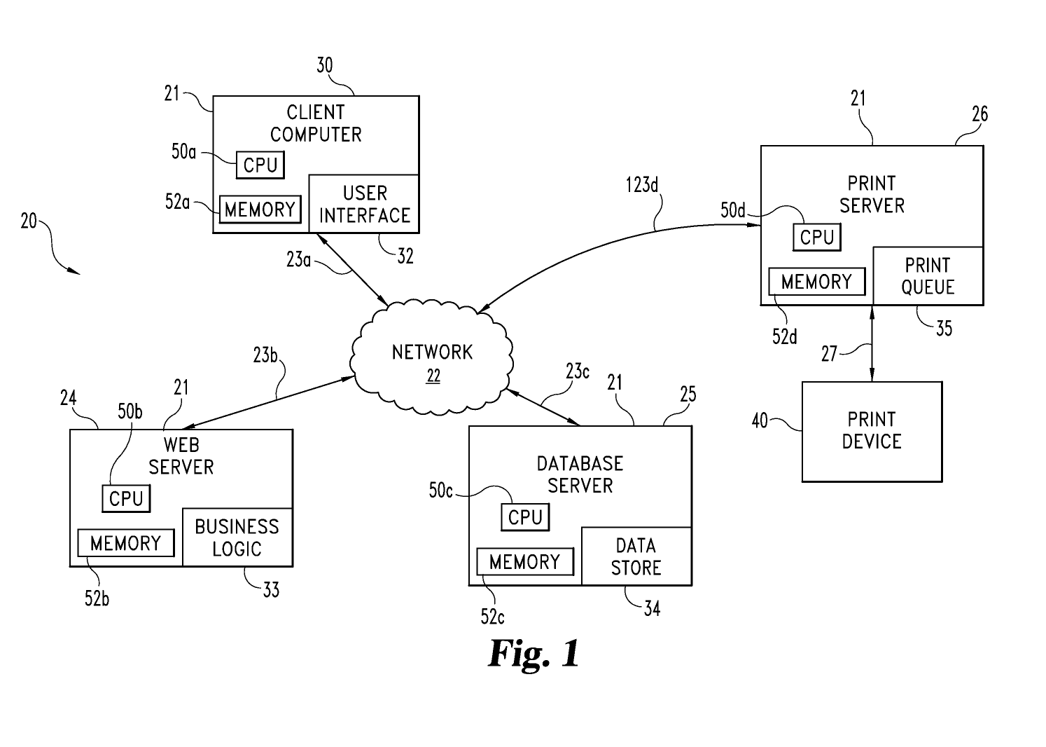

Turning to FIG. 1, a diagrammatic view of a computer system 20 suitable for operation by the service host in one embodiment of the present invention is shown. Computer system 20 includes computer network 22. Computer network 22 couples together a number of computers 21 over network pathways 23a-23d. More specifically, system 20 includes several servers, namely web server 24, database server 25, and print server 26. System 20 also includes a client computer 30 and a print device 40. While computers 21 are each illustrated as being a server or client, it should be understood that any of computers 21 may be arranged to include both a server and one or more client computers. Furthermore, it should be understood that while four computers 21 are illustrated, more or fewer may be utilized in alternative embodiments. In particular, it shall be appreciated that a large number of client computers, such as client computer 30, may be in use within system 20 for performing operations such as allowing numerous individual users to connect to web server 24.

Turning to implementation specifics, in the illustrative embodiment, computers 21 include one or more processors or CPUs (50a, 50b, 50c and 50d respectively) and one or more types of memory (52a, 52b, 52c and 52d respectively). Each memory 52a-d preferably includes a removable memory device. Each processor 50a-50d may be comprised of one or more components configured as a single unit. Alternatively, when of a multi-component form, a processor 50a-50d may have one or more components located remotely relative to the others. One or more components of each processor 50a-50d may be of the electronic variety defining digital circuitry, analog circuitry, or both. In one embodiment, each processor 50a-50d is of a conventional, integrated circuit microprocessor arrangement, such as one or more PENTIUM 4 or XEON processors supplied by INTEL Corporation of 2200 Mission College Boulevard, Santa Clara, Calif. 95052, USA.

Each memory 52a-52d (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown, in one embodiment each computer 21 is coupled to a display and/or includes an integrated display. Computers 21 may be of the same type, or a heterogeneous combination of different computing devices. Likewise, displays may be of the same type, or a heterogeneous combination of different visual devices. Although not shown, each computer 21 may also include one or more operator input devices such as a keyboard or mouse to name just a few representative examples. Also, besides a display, one or more other interface or output devices may be included. As such, various display, input and output device arrangements are possible.

Computer network 22 can be in the form of a wireless or wired Local Area Network (LAN), Municipal Area Network (MAN), Wide Area Network (WAN), such as the Internet, a combination of these, or such other network arrangement as would occur to those skilled in the art. In a further form, several computers 21, such as web server 24, database server 25, and print server 26 may be coupled together by a secure portion of network 22 while remaining connected to client computer 30 via an unsecured portion of network 22. The operating logic of system 20 can be embodied in signals transmitted over network 22, in programming instructions, dedicated hardware, or a combination of these. It should be understood that more or fewer computers 21 can be coupled together by computer network 22.

Print device 40 is connected to print server 26 by connection 27 and may be a combination of one or more printing devices depending upon workload, quality, and throughput requirements. Examples of suitable printers include laser, thermal transfer, ink/bubble jet, dot-matrix, or other print devices known to one of skill in the art of printing and/or publishing. In one embodiment, print device 40 is an array of conventional laser printers, such as one or more DocuTech or DocuColor production printers supplied by Xerox Corporation of Xerox Square, Rochester, N.Y. 14644, USA.

In one embodiment, system 20 operates at one or more physical locations where web server 24 is configured to host application business logic 33 for a letter drafting and personalization service, database server 25 is configured to store user information, content segments suitable for use in letters, and address information for potential recipients, and client computer 30 is configured for providing a user interface 32, for allowing a user to interact with the service, such as to enter user information, create one or more letters, and designate a set of recipients for each letter. It shall be appreciated that in alternate forms client computer 30 may be any web-enabled device, such as a PDA, Blackberry, or mobile phone, to name just a few illustrative examples. Furthermore, user interface 32 of client computer 30 may be an installable application such as one that communicates with web server 24, browser-based, and/or embedded software, to name a few non-limiting examples. In one embodiment, software installed locally on client computers 30 is used to communicate with web server 24. In another embodiment, web server 24 provides HTML pages, data from web services, and/or other Internet standard or company proprietary data formats to one or more client computers 30 when requested. One of ordinary skill in the art will recognize that the term web server 24 is used generically for purposes of illustration and is not meant to imply that network 22 is required to be the Internet.

Additionally, print server 26 includes print queue 35 and associated hardware to receive print jobs comprising user initiated letters for printing and send those jobs to print device 40 for printing. Once the letters are printed, they may then be further processed for delivery to their appropriate destinations.

Typical applications of system 20 would include three centrally located servers, such as web server 24, database server 25, and print server 26, but it will be appreciated by those of ordinary skill in the art that the one or more features provided by those servers could be provided by a single computer or varying other arrangements of computers at one or more physical locations and still be within the spirit of the invention.

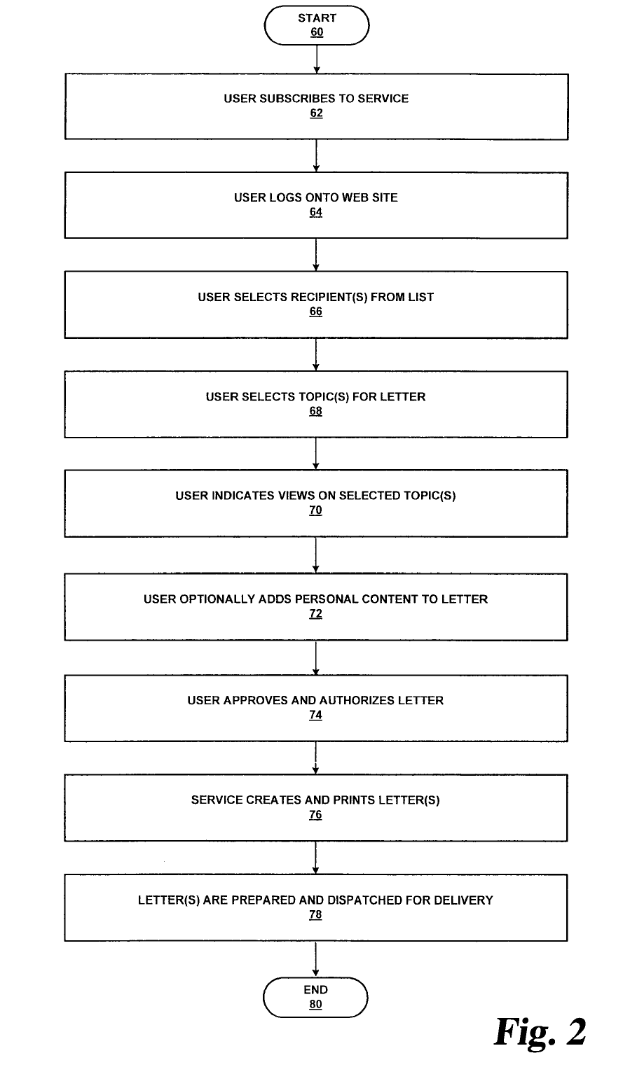

Turning to FIG. 2, with continued reference to FIG. 1, the stages involved in creating a letter for distribution using the service in the illustrated embodiment are illustrated in flowchart form. The process begins at start point 60 with the user subscribing to the service (stage 62). In order to subscribe, the user logs onto a web site hosted by web server 24 and operated by the service host, such as by use of client computer 30. In one form, the user completes one or more web forms which may request and/or require information such as the user's name, address, and nine-digit zip code. The user may also create or be assigned a unique user id and/or password combination in order to allow later access to the service through the web site. In addition, the user selects a payment plan, such as one having a monthly allowance of letters, and arranges for billing or payment. In the event a user is already a member of the service, such as by completing an alternate registration process, this step may be omitted.

Once registered, the user logs onto the service web site by entering a username/password combination (stage 64). In order to create a new letter, the user must first select one or more recipients. Based upon the user's associated nine-digit zip code the service dynamically populates a list of the elected officials who represent the user for selection. The officials may include federal, state, and local government officials. In a further form, the list of potential recipients for the user to select from may also include other government officials such as cabinet members and other appointed officials. The user then selects one or more recipients for the letter from this list (stage 66). Once the recipients have been selected, the user next selects the topic or subject area for the letter (stage 68). For example, a user with a strong opinion regarding global warming may select fossil fuel reduction as a topic for a letter being addressed to the President, Vice President, and the Secretary of the Department of Energy. After selecting a topic, the user then indicates his views on the particular topic (stage 70), such as in support of or opposed to. In the example of fossil fuel concern, the user may be for alternate fuel development or the user may be for oil exploration. In one form, the service utilizes the topic selected by the user and their expressed views to generate a form letter explaining the user's position to the recipient. The form letter may include facts, stories, examples, suggestions, or other information collected and provided to the service.

Once the form letter is generated by the service, the user is provided the opportunity to revise the letter (stage 72) by adding personal messages as free form text or re-arrange the letter by adding/removing/re-ordering form segments. In a preferred form, the service performs an approval process of the text submitted to screen for vulgar language, threats, and other impermissible correspondence. This process may be automated using detection algorithms or otherwise. Additionally, in another form, the service also includes a generated signature of the user's name in order to make the letter appear more personal. In a still further form, the user may upload in an image file or otherwise provide a copy of their signature for use by the service on the letters generated. Once completed, the user approves the letter (stage 74).

The approved letter, combined with the selected recipients and their associated addresses stored by data store 134 allows the service to generate the unique letters addressed to the recipients. Each letter is then printed (stage 76) and prepared for dispatch. Preparations may include folding, placing in an envelope, stamping, sorting, etc. The letters are then dispatched for delivery (stage 78) such as with the delivery services described herein or otherwise. The process ends at endpoint 80.

In an alternate embodiment, the service may be provided to users through or sponsored by various organizations, associations, unions, or the like. This alternative subscription model allows members of the subscribing entity to access the service for the limited purpose of sending letters to a selected type of recipients, such as Congressional representatives, with respect to a subset of issues which are germane to the entity. This subscription method also allows the casual user to send a letter on a specific issue with no personal out-of-pocket expense.

In a further embodiment, the service stores a user profile for each, inclusive of biographical information and the like. The user profile may also store associated information indicating the political views of the user as derived from their use of the service. The database server 25 processes this information and allows for a subscribing super user, such as a political candidate, to obtain lists of users who have strong views on one side of a selected issue. Therefore, using these lists, a candidate may select users from within his voting district, a state holding an upcoming primary, or other location and have the service send a personalized letter to each of the users listed introducing themselves and explaining their views on the issue which the user feels strongly about. In a still further form, based upon each user profile, a letter may be built for each user addressing several issues they feel strongly about from previously written text supplied by the candidate to the service. Based upon this wealth of information, the political views of a user and their relative strength can be discerned from the topics, frequency, and quantity of letters they send, allowing a super user to directly address the issues most relevant to a large number of politically active users.

While the invention has been illustrated and described in detail in the drawings and foregoing description, the same is to be considered as illustrative and not restrictive in character. Only the preferred embodiment, and certain alternative embodiments deemed useful for further illuminating the preferred embodiment, have been shown and described. All changes and modifications that come within the spirit of the invention are desired to be protected.

What is claimed is:

1. A method for providing automated physical correspondence comprising the steps of:
storing a plurality of templates within an electronic database,
wherein each of said templates is associated with a topic and comprises a block of text suitable for use in a piece of correspondence regarding that topic;
receiving a request to send correspondence to a selected entity from a remote user over an electronic network;
transmitting a list of potential topics to the remote user over said electronic network;
receiving a selection including at least one topic from said list of potential topics from the remote user;
generating a piece of correspondence addressed to the selected entity and from the remote user using predetermined content associated with each topic in said selection; and
delivering said piece of correspondence to the specified entity utilizing a selected delivery method.

2. The method of claim 1, wherein said generating step comprises the step of printing a physical copy of an electronic document.

3. The method of claim 2, wherein said selected delivery method is first-class mail.

4. The method of claim 3, wherein said piece of correspondence is a letter.

5. The method of claim 3, wherein said piece of correspondence is a postcard.

6. The method of claim 1, further comprising the steps of:
receiving a zip code from the remote user; and
transmitting a list of entities of interest associated with said zip code to the remote user prior to receiving said request to send correspondence.

7. The method of claim 6, wherein said list of entities of interest is generated by querying an electronic database using said zip code.

8. The method of claim 6, wherein said zip code is a nine digit zip code.

9. The method of claim 6, wherein said selected entity is selected from said list of entities of interest.

10. The method of claim 6, wherein said list of entities of interest is a list of at least a portion of the public officials serving the residents having said zip code.

11. The method of claim 10, wherein said list of entities of interest is a list of at least a portion of the elected officials elected by the residents having said zip code.

12. The method of claim 1, wherein said list of entities of interest includes at least one of:
congressional representatives, governor, mayor, or president.

13. The method of claim 7, wherein the address of the selected entity is stored in said electronic database.

14. The method of claim 7, wherein the address of each of the entities within said list of entities is stored in said electronic database.

15. The method of claim 1, wherein said block of text comprises at least 50 words.

16. The method of claim 15, wherein said block of text comprises at least 100 words.

17. The method of claim 1, further comprising the step of:
receiving a signature of the remote user; and
reproducing said signature in the closing of said piece of correspondence.

18. The method of claim 17, wherein said signature is received electronically.

19. The method of claim 17, wherein said signature is digitally reproduced.

20. The method of claim 17, wherein said signature is received via first-class mail.

21. The method of claim 1, further comprising the step of:
receiving edits to said piece of correspondence from the remote user.

22. The method of claim 1, further comprising the step of:
billing a sponsoring entity associated with the remote user for said delivering.

23. A method for providing automated physical correspondence comprising the steps of:
receiving a request to send correspondence to a selected entity from a remote user over an electronic network;
receiving a portion of text suitable for the body of a latter from the remote user;
generating a piece of correspondence addressed to the selected entity and from the remote user using said portion of text; and
delivering said piece of correspondence to the specified entity utilizing a selected delivery method.

24. The method of claim 23, wherein said selected delivery method is first-class mail.

25. The method of claim 24, wherein said request includes the mailing address of said selected entity.

26. A method for providing correspondence to users of a system based upon their prior use comprising the steps of:
receiving a request to send correspondence to a selected entity from a remote user over an electronic network;
transmitting a list of potential topics to the remote user over said electronic network;
receiving a selected topic from said list of potential topics and a favorable or unfavorable stance regarding said topic from the remote user;
generating a piece of correspondence addressed to the selected entity and from the remote user using predetermined content associated with said topic and said stance;
delivering said piece of correspondence to the specified entity utilizing a selected delivery method;
storing said topic and said stance in a user profile associated with the remote user;
receiving a second content segment associated with said selected topic and said stance from a second remote user;
generating a second piece of correspondence addressed to the remote user and from the second remote user using said second content segment; and
delivering said piece of correspondence to the remote user utilizing said selected delivery method.

27. The method of claim 26, wherein said generating steps comprises the step of printing a physical copy of an electronic document.

28. The method of claim 27, wherein said selected delivery method is first-class mail.

29. The method of claim 28, wherein said piece of correspondence is a letter.

30. The method of claim 26, wherein said predetermined content and said second content segment each individually comprise at least 50 words.

31. The method of claim 30, wherein said predetermined content and said second content segment each individually comprise at least 100 words.

32. The method of claim 26, further comprising the step of:
receiving a signature of the remote user; and
reproducing said signature in the closing of said piece of correspondence.

33. The method of claim 26, further comprising the step of:
receiving a signature of the second remote user; and
reproducing said signature in the closing of said second piece of correspondence.

34. The method of claim 26, wherein the second remote user is a political candidate.
